(19) United States
(12) Patent Application Publication
(10) Pub. No.: US 2008/0148155 A1
(43) Pub. Date: Jun. 19, 2008

(54) REAL-TIME MONITOR INTEGRATED ACTIVITY THREAD SNIPPETS

(76) Inventors: Sandra L. Kogan, Newton, MA (US); Eric M. Wilcox, Cambridge, MA (US); Charles R. Hill, Belmont, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/612,154

(22) Filed: Dec. 18, 2006

(51) Int. Cl. G06F 15/177

(52) U.S. Cl. 715/736

(57) ABSTRACT

Embodiments of the present invention address deficiencies of the art in respect to real-time monitoring of activity metrics in an activity-centric collaborative computing environment and provide a novel and non-obvious method, system and computer program product for real-time monitor integration of activity thread snippets in an activity-centric collaborative computing environment. In one embodiment of the invention, a method for real-time monitor integration of activity thread snippets in an activity-centric collaborative computing environment can be provided. The method can include collecting real-time metrics for an activity object in an activity thread, changing characteristics of a control element within an enterprise dashboard view according to the collected real-time metrics, and inserting into the control element a portion of the activity thread.

### BACKGROUND OF THE INVENTION

1. Field of the Invention

The present invention relates to the field of collaborative computing and more particularly to real-time monitoring of tasks in an activity-centric collaborative computing environment.

2. Description of the Related Art

Collaborative computing refers to the use by two or more end users of a computing application in order to achieve a common goal regardless of whether they are co-located or geographically dispersed or communicating synchronously or asynchronously. Initially envisioned as a document sharing technology among members of a small workgroup in the corporate environment, collaborative computing has grown today to include a wide variety of technologies arranged strategically to facilitate collaboration among groups as small as two people, or as large as a world-wide community. Thus, different collaborative applications may focus upon groups of different sizes. No longer merely restricted to document sharing, the modern collaborative environment can include document libraries, chat rooms, workflow, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, many goals and objectives can be achieved only through the participation of a multiplicity of individuals and systems, each serving a specified role or roles in the process. Consequently, to provide computing tools designed for use only by one of the individuals in the process can be short sighted and can ignore important potential contributions lying among the other individuals involved in the process. It also might be counter productive to the individual and create more of a burden on the individual's workload requiring checking each system or tool, or checking-in with various people. This entails a lot of heavy lifting and a heavy cognitive load requiring one to remember each system, tool and person involved and to remember to check for updates and changes.

An activity-centric collaborative computing environment provides an enhanced form of the collaborative computing environment by enabling a task and activity paradigm for driving a collaborative goal for groups of collaborators on a project. In an activity-centric collaborative computing environment, a project can be viewed as a collection of different tasks and task-related work product and ad hoc communications arranged in a hierarchy providing a view to the entirety of the activity. Each node in the hierarchy can further be associated with one or more assigned roles. To the extent that any given node in the hierarchy is a task, the task can include an associated start date and a proposed duration such that the entire activity can be viewed as a project plan on a time line.

Different sub-trees of the hierarchy can represent discrete units of work to be achieved in driving a parent activity to completion. Referred to as an activity-thread, the progress of the associated roles in completing the tasks of the activity thread can be real-time monitored to track whether the tasks are likely to complete on schedule, in danger of failing to complete on schedule, or in fact unlikely to complete on schedule. An end user, at a glance, can view the activity thread in a hierarchical view of the activity to readily identify those tasks deemed to be “in trouble.

To facilitate a view of real-time monitoring, activity-centric collaborative environments provide an enterprise dashboard view of critical information. As part of the enterprise dashboard view, a heat map can be rendered in which different roles associated with an activity can be displayed with varying background colors increasing in intensity as it becomes more likely that the roles will be unable to complete an associated task for the activity. In this way, a viewer can contact the role with the “hottest” symbol to assess the situation and to “drill down” into real-time information available in for the activity. Similarly, as part of enterprise dashboard view, a scorecard can be rendered in which different tasks associated with an activity can be displayed with completion metrics such as a target value, an actual value, and a variance.

Notwithstanding, real-time monitored metrics for an activity object in an activity can vary in meaning depending upon the nature of the monitored activity object. In some circumstances, metrics indicating a failure to meet a target may not be alarming for the viewer depending upon the importance inherent to the activity object. In other circumstances, the opposite may be true. Yet, the enterprise dashboard for an activity-centric collaborative environment lacks context to associate real-time monitored data with the nature of the subject matter of the real-time monitored activity object. To acquire the requisite context, a viewer must separately explore the activity, or physically contact one or more of the associated roles for the activity.

### BRIEF SUMMARY OF THE INVENTION

Embodiments of the present invention address deficiencies of the art in respect to real-time monitoring of activity metrics in an activity-centric collaborative computing environment and provide a novel and non-obvious method, system and computer program product for real-time monitor integration of activity thread snippets in an activity-centric collaborative computing environment. In one embodiment of the invention, a method for real-time monitor integration of activity thread snippets in an activity-centric collaborative computing environment can be provided. The method can include collecting real-time metrics for an activity object in an activity thread, changing characteristics of a control element within an enterprise dashboard view according to the collected real-time metrics, and inserting into the control element a portion of the activity thread.

In another embodiment of the invention, an activity-centric collaborative computing data processing system can be provided. The system can include an activity-centric collaborative tool configured to manage and arrange activities, each including at least one activity thread. The system also can include a real-time monitor configured to collect real-time metrics for selected activity objects in different ones of the activities. The system yet further can include at least one dashboard view of the real-time metrics. The dashboard view can include at least one control element configured with changing display characteristics according to collected real-time metrics. Finally, the system can include activity thread integration logic. The activity thread integration logic can include program code enabled to insert into the control element a portion of an activity thread associated with a selected activity object for the collected real-time metrics.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1A is a pictorial illustration of an enterprise dashboard heatmap configured for real-time monitor integration of activity thread snippets;

FIG. 1B is a pictorial illustration of an enterprise dashboard scorecard configured for real-time monitor integration of activity thread snippets;

FIG. 2 is a schematic illustration of an activity-centric collaborative computing environment configured for real-time monitor integration of activity thread snippets; and,

FIG. 3 is a flow chart illustrating a process for real-time monitor integration of activity thread snippets in an activity-centric collaborative computing environment.

### DETAILED DESCRIPTION OF THE INVENTION

Embodiments of the present invention provide a method, system and computer program product for real-time monitor integration of activity thread snippets. In accordance with an embodiment of the present invention, metrics for one or more activity objects within an activity thread of an activity can be monitored in real-time. Concurrently, an enterprise dashboard view of the metrics can be provided. Within selected controls displaying the metrics in the enterprise dashboard view, related portions of the activity thread can be inserted. In this way, the insertion of the portions of the activity thread can provide context for the metrics in each of the selected controls.

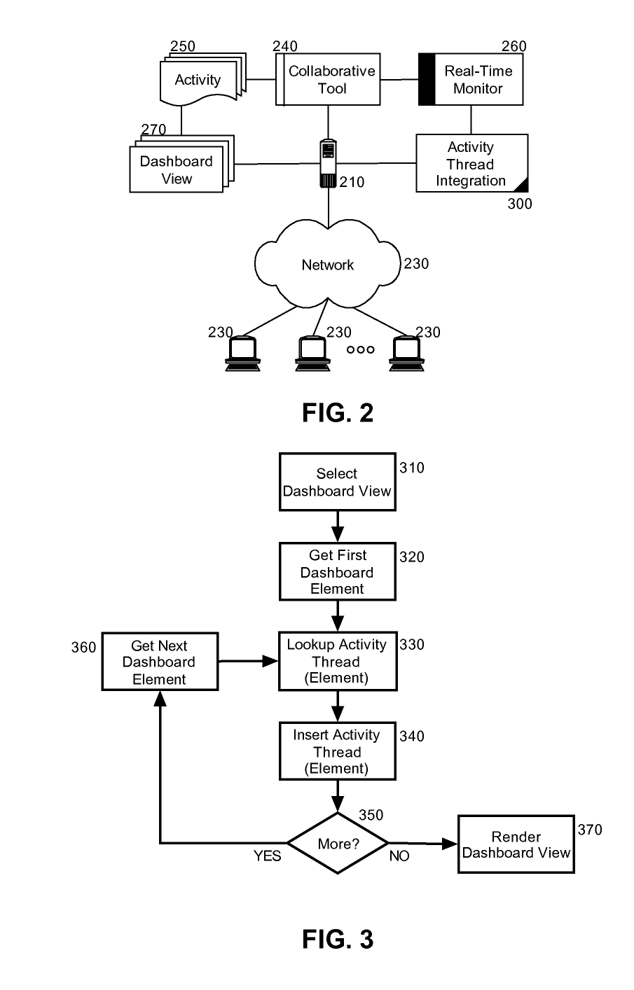

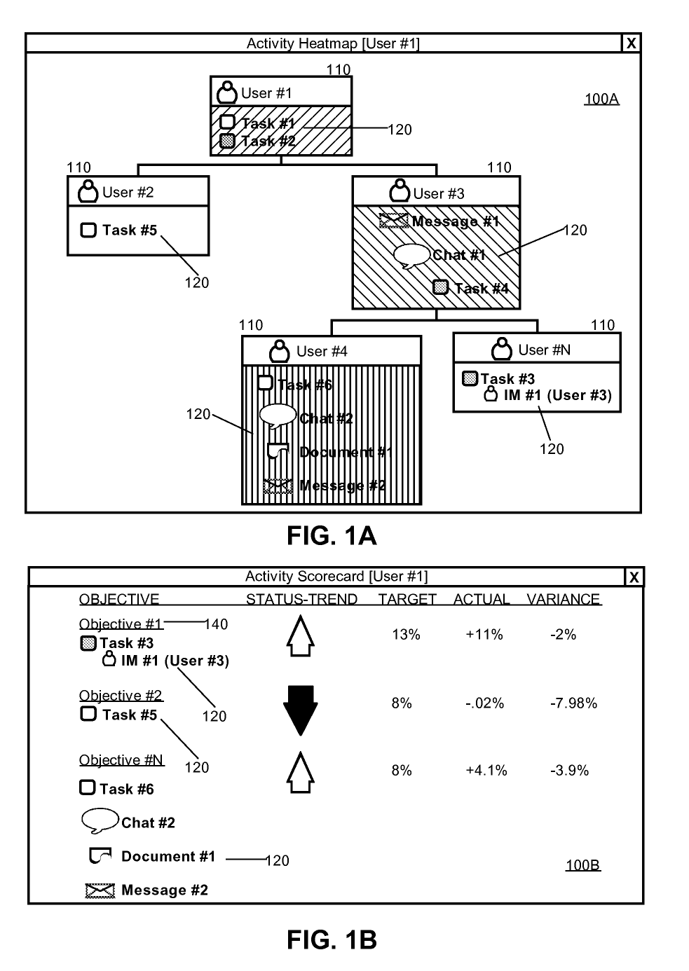

In illustration, FIG. 1A shows an enterprise dashboard view configured for real-time monitor integration of activity thread snippets. The enterprise dashboard view can include a heatmap 100A including a hierarchy of interrelated nodes 110, each node being associated with a user and providing both presence awareness and an indication of a role. Each of the nodes 110 can be a visual control corresponding to a collection of real-time monitored metrics associated with an activity, for example a collection of real-time monitored metrics for activity objects in an activity associated with particular users assigned to the activity. Each of the nodes 110 further can include visual display characteristics such as background color that change according to the likelihood that the activity objects for the node will be completed as required. To provide context for each of the nodes 110, an activity thread snippet 120 of the activity objects corresponding to the metrics of the node can be included in each of the nodes 110.

FIG. 1B likewise illustrated an enterprise dashboard view. In FIG. 1B, the enterprise dashboard view can include a scorecard 110B. The scorecard 110B can include a table of objectives 140 for an activity. Each of the objectives 140 can be associated with a set of activity objects in an activity thread for the activity and real-time monitored metrics can be collected for the activity objects. As a result, the real-time monitored metrics can be displayed in association with corresponding ones of the objectives 140. As before, to provide context for each of the objectives 140, an activity thread snippet 120 of the activity objects for respective ones of the objectives 140 can be included in the respective ones of the objectives 140.

In further illustration, FIG. 2 is a schematic illustration of an activity-centric collaborative computing environment configured for real-time monitor integration of activity thread snippets. The computing environment can include a host computing platform 210 coupled to multiple different collaborative clients 230 over a computer communications network 230. The host computing platform 210 can support the operation of a collaborative tool 240 such as an activity-centric collaborative computing application.

In this regard, the collaborative tool 240 can manage an arrangement of activities 250, each activity providing at least one set of activity objects arranged in an activity thread. A real-time monitor 260 further can be coupled to the collaborative tool 260 and can include a configuration for monitoring selected ones of the activity objects in the activity thread and collecting metrics pertaining to the monitored activity objects. To provide for a visualization of the collected metrics, one or more enterprise dashboard views 270 of the metrics can be provided by the combined operation of the real-time monitor 260 and collaborative tool 240, the enterprise dashboard views 270 including a heatmap and a scorecard, for example.

Finally, activity thread integration logic 300 can be coupled to the host computing platform 210. The activity thread integration logic 300 can include program code enabled to retrieve different activity thread snippets for corresponding controls in a selected one of the enterprise dashboard views 270. The program code of the activity thread integration logic 300 further can be enabled to insert the different activity thread snippets in the corresponding control in the selected one of the enterprise dashboard views 270 so as to provide context for the metrics represented within the controls in the selected one of the enterprise dashboard views 270.

In yet further illustration, FIG. 3 is a flow chart illustrating a process for real-time monitor integration of activity thread snippets in an activity-centric collaborative computing environment. Beginning in block 300, a dashboard view can be selected for displaying real-time monitored metrics for different selected activity objects in an activity thread. In block 320, a first dashboard control element in the enterprise dashboard view can be retrieved and the activity objects associated with the first dashboard control element can be located. The activity objects can include tasks, messages, chats, documents, instant messages, workflow, blog posts, and wiki updates. Thereafter, in block 340, the activity objects can be inserted into the first dashboard control element. Finally, in decision block 350, if additional dashboard control elements remain to be retrieved, in block 360 a next dashboard element for the enterprise dashboard view can be retrieved and the process can repeat through block 330. When no further dashboard control elements remain, the process can end in block 370.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for real-time monitor integration of activity thread snippets in an activity-centric collaborative computing environment, the method comprising:
collecting real-time metrics for an activity object in an activity thread;
changing characteristics of a control element within an enterprise dashboard view according to the collected real-time metrics; and,
inserting into the control element a portion of the activity thread.

2. The method of claim 1, wherein changing characteristics of a control element within an enterprise dashboard view according to the collected real-time metrics, comprises changing a background color of a node within a heatmap according to the collected real-time metrics.

3. The method of claim 2, wherein collecting real-time metrics for an activity object in an activity thread, comprises collecting real-time metrics for an activity object associated with a user belonging to the activity thread.

4. The method of claim 1, wherein changing characteristics of a control element within an enterprise dashboard view according to the collected real-time metrics, comprises changing displayed numerical statistics for an objective within a scorecard according to the collected real-time metrics.

5. The method of claim 2, wherein collecting real-time metrics for an activity object in an activity thread, comprises collecting real-time metrics for an activity object associated with an object derived from the activity thread.

6. An activity-centric collaborative computing data processing system comprising:
an activity-centric collaborative tool configured to manage and arrange a plurality of activities each of the activities comprising at least one activity thread;
a real-time monitor configured to collect real-time metrics for selected activity objects in different ones of the activities;
at least one dashboard view of the real-time metrics, the dashboard view comprising at least one control element configured with changing display characteristics according to collected real-time metrics; and,
activity thread integration logic comprising program code enabled to insert into the control element a portion of an activity thread associated with a selected activity object for the collected real-time metrics.

7. The system of claim 6, wherein the activity objects comprises activity objects selected from the group consisting of tasks, messages, chats, documents, instant messages, workflow, blog posts, and wiki updates.

8. The system of claim 8, wherein the dashboard view comprises a heat map.

9. The system of claim 8, wherein the dashboard view comprises a scorecard.

10. A computer program product comprising a computer usable medium embodying computer usable program code for real-time monitor integration of activity thread snippets in an activity-centric collaborative computing environment, the computer program product comprising:
computer usable program code for collecting real-time metrics for an activity object in an activity thread;
computer usable program code for changing characteristics of a control element within an enterprise dashboard view according to the collected real-time metrics; and,
computer usable program code for inserting into the control element a portion of the activity thread.

11. The computer program product of claim 10, wherein the computer usable program code for changing characteristics of a control element within an enterprise dashboard view according to the collected real-time metrics, comprises computer usable program code for changing a background color of a node within a heatmap according to the collected real-time metrics.

12. The computer program product of claim 11, wherein the computer usable program code for collecting real-time metrics for an activity object in an activity thread, comprises computer usable program code for collecting real-time metrics for an activity object associated with a user belonging to the activity thread.

13. The computer program product of claim 10, wherein the computer usable program code for changing characteristics of a control element within an enterprise dashboard view according to the collected real-time metrics, comprises computer usable program code for changing displayed numerical statistics for an objective within a scorecard according to the collected real-time metrics.

14. The computer program product of claim 11, wherein the computer usable program code for collecting real-time metrics for an activity object in an activity thread, comprises computer usable program code for collecting real-time metrics for an activity object associated with an object derived from the activity thread.
